(19) United States
(12) Patent Application Publication
(10) Pub. No.: US 2016/0037744 A1
(43) Pub. Date: Feb. 11, 2016

(54) Device For Pets

(71) Applicant: Mats Rudin, Fagersta (SE)

(72) Inventor: Mats Rudin, Fagersta (SE)

(21) Appl. No.: 14/885,936

(22) Filed: Oct. 16, 2015

Related U.S. Application Data
(63) Continuation-in-part of application No. PCT/SE2014/050392, filed on Apr. 2, 2014.

(30) Foreign Application Priority Data
Apr. 17, 2013 (SE) 1350483-2

(51) Int. Cl. A01K 1/035; A01K 5/01

(52) U.S. Cl. CPC A01K 1/0353; A01K 5/0107; A01K 5/0135

(57) ABSTRACT

Disclosed is a device for pets, comprising a base, having a resting area, and the resting area comprising a container-receiving area having a recess. A container, such as a bowl or tray, is removably received in the recess. In use the container is supported by the base within the recess and is less prone to being moved in relation to the base or tipped over.

### CROSS-REFERENCE TO RELATED APPLICATIONS

This application is a continuation-in-part of PCT/SE2014/050392 which is entitled “Device For Pets” and which was filed on Apr. 2, 2014. This continuation-in-part claims benefit of foreign priority to SE 1350483-2 which was filed on Apr. 17, 2013, and which is entitled “Anordning For Sallskapsdjur” (Translated: “Device for Pets”). This application claims the benefit of foreign priority to SE 1350483-2 which was filed on Apr. 17, 2013, through PCT/SE2014/050392 filed on Apr. 2, 2014.

### INCORPORATION BY REFERENCE

This continuation-in-part incorporates by reference in its entirety copending PCT Application No. PCT/SE2014/050392 which is entitled “Device For Pets” and which was filed on Apr. 2, 2014, which incorporates by reference in its entirety SE 1350483-2 which was filed on Apr. 17, 2013, and which is entitled “Anordning For Sallskapsdjur” (Translated: “Device for Pets”) and which is also incorporated by reference herein.

### FIELD OF THE INVENTION

The present invention pertains to a device for pets comprising a base having a resting area, and a recessed container, for use in particular when travelling with a pet.

### BACKGROUND TO THE INVENTION

In the present context, ‘pets’ refers to domesticated animals, including mammals such as dogs, cats, rodents and rabbits, but also pet pigs and African pygmy hedgehogs.

Furthermore, in the present context, the term ‘container’ includes bowls and other similar open containers for food, water and the like, but the term also includes bowls provided with covers or other closure means.

When a person owning a pet is away from home with the pet, e.g. for exhibiting it, or just to pay a visit, travelling by car or other vehicle, it may be difficult to give the pet the same sense of well-being as at home. It may be missing its comfortable rug to lie on, and it may tip over food and/or water bowls, so that the food/water spills out onto someone's floor or onto the ground.

As can be seen from WO 97/48272, one way of preventing a food/water bowl from tipping over is to place it in a support, which in one embodiment may consist of a circular plate with a slightly larger diameter that the largest diameter of the bowl.

Pet mats of different shapes have been available for a long time. A combination device of a mat and container is disclosed in U.S. Pat. No. 4,907,539 A1, wherein the pet mat consists of a divided food and water bowl, which is centered and anchored on a rubber mat by means of rubber protrusions.

Another known pet mat is disclosed in EP 0 578 133 A2. The pet mat disclosed therein is a combination mat, wherein the bottom edge of the container is located below the mat, which on at least one side of the bowl has a sufficient length to allow an animal to rest its front paws on the mat while eating or drinking, the weight of the animal secures the mat to the ground. The bowl and the mat are further provided with reciprocal hooking means to prevent the bowl from moving relative to the mat.

US 2005/0211175 A1 discloses a bag-shaped, portable sleeping pad for pets with generally laminated walls, which at least on one side are partially covered with material adapted to be comfortable to a pet lying on the walls after unfolding them. In the shown embodiment, the two long sides of the bag are connected to the top side thereof via hinge joints and form the sleeping pad after unfolding. The use of a container is not discussed.

U.S. Pat. No. 6,516,745 B1 discloses a pet travelling bag, which integrates a sleeping pad for the pet with a food and water storage system for use when travelling with pets. The bag comprises a folding shell, which carries a cushion for use by the pet to sleep or rest and a mesh pocket for use in transporting items the pet may need, such as e.g. medicine and toys. At the fold line connecting the two sides of the shell to each other, sealable containers, adapted to hold food and water, are releasably affixed to a material extending along the fold line, which also provides rigidity and support to the fabric shell. Accordingly, the containers are attached to the fold line of the shell.

US 2006/0288953 A1 discloses a bag of suitcase-type, constructed with a nylon-type fabric, which has been treated with a heavy urethane coating on the back side and a wear-resistant, water repellent topical surface. Internally, the bag is divided into two halves; one half containing an easily removable, contoured, washable pet sleeping mat, and a second half containing on the one side durable, washable, spill-proof, unfixed food/water bowls, and on the other side a pouch, provided with a rust-resistant zipper, for pet items.

In use of the devices mentioned above, the container may be prone to come loose and possibly tip over, and/or the mat or container may be difficult to clean, e.g. to remove unwanted food residues in the container attachment. There is a need for a portable device for pets which addresses or mitigates one or more of the problems of the prior art devices.

### SUMMARY OF THE INVENTION

According to an aspect of the invention, there is provided a device for pets, comprising a base, having a resting area, and the resting area comprising a container-receiving area having a recess for fitting therein a container. The device may comprise a container, such as a bowl or tray, sized to be received, for example cooperatively, in the recess.

Accordingly, in use the container is supported by the base within the recess and is less prone to being moved in relation to the base or tipped over. Moreover, since the container is retained in a recess (rather than extending through an aperture in the base, for example), it moves together with the base and does not directly contact the surface on which the base is resting. Thus, when the base is moved or dragged for example by a pet, the container does not drag and is not prone to tipping or snagging; which might otherwise cause contents to be spilled.

The container may be removable from the recess.

The container may be integral to the device (i.e. permanently attached in the recess).

When received in the recess, the container may be partly or fully recessed into the base. That is to say, at least a part of the container may extend above the level of the resting area, or alternatively, an upper part of the container (e.g. a rim around the container) may be flush or substantially flush with the level of the resting area. In some embodiments, an upper part of the container may be below the level of the resting area.

The container may be provided with a lid (typically a removable lid). When installed on the container, the lid may be flush, or substantially flush with the level of the resting area.

The lid may extend smoothly from the resting area, for example at an angle of less than around 30 degrees, 15 degrees or 10 degrees from the resting area. Thus, no sharp angles are presented to a pet, by which the container and/or lid might be caught or tipped by the pet.

The lid may be generally flat. The lid may be domed. The lid may slope towards the base of the container, from the periphery thereof (i.e. downwardly, in normal use).

The lid may be provided with an aperture, or may have an openable flap so as to provide an aperture through the lid. The aperture may be generally central to the container, such that the lid defines an anti-spill lip around the container.

The container may comprise an anti-spill lip around an upper periphery thereof, which may extend smoothly from the resting area. The lid may be sized to fit within the anti-spill lip, so as to selectively cover the container.

The lid may be tearable or frangible. For example, the container may be provided with a plastics film lid or a foil lid. In some embodiments, the container (and/or lid) may be a single use item.

The device may comprise a lid, configured to selectively cover the recess, when a container is not present.

The base may be flexible. The base may be foldable. The base may be constructed from a flexible material such as a plastics or foam material. The base may comprise a cellular plastics material, such as expanded polystyrene or polyethylene.

The base may have a generally uniform thickness, although the thickness may in some embodiments vary across the base. For example certain regions of the base may have a greater thickness, to provide padding or additional padding to certain parts of the resting area. Alternatively, or in addition, certain regions of the base may have a reduced thickness, for example to facilitate rolling or folding.

The base may comprise a hinge (or more than one hinge), to enable the base to be folded or rolled. The base may for example comprise an active hinge (e.g. a region across the base having a reduced thickness, or formed from a more flexible material than adjacent regions of the base).

The base may be resilient, so as to have a tendency to unfurl or unroll to a generally flat configuration. The resilience or stiffness of the base may be greater in one direction than another direction, such that the base may be more easily folded or rolled in a particular direction.

The base may comprise a core. The core may be flexible and/or resilient.

The device may be provided with a closure, to selectively retain the base in a folded or rolled configuration. For example; a foldable base may be provided with a latch, or a foldable or rollable base may be held in a folded/rolled configuration using a strap. The device may be provided with a carrying handle or shoulder strap.

The base may be padded, so as to provide a comfortable resting area for a pet. Abase comprising or constructed from resilient material may for example provide a degree of padding to the resting area.

The container-receiving area may be reinforced. In use, for example when feeding or drinking from a container in the recess, a pet is liable to apply additional weight or force to the area around the container. Reinforcing of the container-receiving area reduces the possibility of tipping the container or spilling its contents. Such reinforcement is particularly advantageous in embodiments comprising a padded or resilient base, which compress under the weight of a pet.

The container-receiving area may for example be provided with additional stiffness, as compared to the adjacent portions of the base. The container-receiving area may be formed from a stiff plastics material, for example. A portion of the core, in the region of the container-receiving area, may be reinforced (e.g. formed from a stiffer material than other portions of the core).

The reinforcement of the container-receiving area may extend around a part, or entirely around, the recess. The reinforcement may extend a part or substantially the entire thickness of the base, so as to provide a firm platform or support a container in the recess.

The recess (and thus also the container) may have tapered walls, to facilitate insertion or removal of the container.

The recess may have a depth which is less than a thickness of the base. For example the depth of the recess may be around half, or 75%, or 80% or 90% or more, of the thickness of the base.

The device may take the form of a mat, which may be configured to be laid out to provide a generally flat resting area (upon which an animal may lie, sleep, sit or stand), comprising a container-receiving area having a recess for fitting therein a container.

The container-receiving area may be positioned anywhere in the base, but may conveniently positioned towards an edge or corner of the base.

The base may be of any suitable size or shape, for example square, rectangular, oval, circular, and so forth; as required for a given application. For example, a square or rectangular base may be particularly suited for use in a motor vehicle or an animal cage. Indeed, the base may be adapted for use in a specific location, such as the trunk or flat-bed of a vehicle (e.g. the base may be provided with cut outs for wheel arches, and/or attachments for securing the device to a vehicle).

The base may comprise rounded corners or edges.

The base may comprise more than one container-receiving area, each having a recess. The container receiving area may comprise more than one recess.

The device may comprise more than one container.

For example, it may be convenient for separate containers to be used for food and water. In use, a food container may be placed in the recess for feeding, to be replaced by a water bowl at other times. Alternatively, food and water containers may be placed in adjacent recesses.

The device may take the form of a mat or bed for an animal.

The container-receiving area and/or adjacent region of resting area may be easily cleanable or wipeable. The entire device may be easily cleanable/wipeable. The device, or said regions thereof, may be formed from, coated or covered with a washable or wipeable material such as a smooth plastics material. The device, or said regions thereof, may be formed from, coated or covered with a water-impermeable material.

The base may comprise a core and a cleanable, wipeable and/or washable cover or coating around the core.

The base may comprise a removable cover (e.g. for washing, or replacement when worn).

The device or particular portions thereof may lack seams or stitching, in particular between the container-receiving area and the adjacent resting area, so as to avoid collecting food, hair or other debris. The device may comprise for example taped, welded or glued seams between component parts, in particular around the recess.

According to another aspect of the invention there is provided a kit of parts for a device for pets, comprising a base, having:

a resting area, and the resting area comprising a container-receiving area having a recess for fitting therein a container; and
at least one container, such as a bowl or tray, sized to be removably received, for example cooperatively, in the recess.

The kit may comprise more than one container.

The kit may comprise one or more lids, for covering a said container, or recess, as the case may be.

The kit may comprise one or more pre-packaged containers, which may be single use containers. A single use container may comprise, for example, an amount of food suitable for a single meal for a pet.

In another aspect, the invention provides a device for pets, comprising two halves folding together, wherein one of the halves comprises a container receiving area for receiving a container, and wherein at least the other half is designed as a sleeping area for the pet, characterized in that said container receiving area in one of the halves has a recess for fitting therein the container, and that said one of the halves, at least in the container receiving area, has a thickness corresponding at least to the height of the container, so that the container is recessed into said one of the halves and has a top edge substantially flush with a top surface of said container receiving area in one of the halves when the device is in an unfolded position.

The container receiving area (which may be in said one of the halves) may have a core comprising hard cellular plastic (such as expanded polystyrene). The other half, which may be a sleeping area may have a core comprising soft cellular plastic.

The device may be provided with a surface of a water-impermeable material and/or anti-slipping material.

The device may comprise laminated walls. Foldable embodiments of the invention may be configures such that the laminated walls are placed on the outside of the device when in a folded position. When the device is in the unfolded position, a top surface (such as a resting area) of a material comfortable for a pet to lie on may be provided. The comfortable material may be attached to (for example coated or covered with) a water-impermeable and/or anti-slipping material. The device may be completely covered on the inside and outside with water impermeable or anti-slipping material.

The container may be constructed from any suitable material, including but not limited to metal (such as stainless steel), a plastics material (such as polyethylene, PTFE, nylon or the like) or paper (such as a plasticized paper).

The container may comprise means, such as a cover or a tearable foil or film, for retaining food or liquid in the container during transport.

The two halves of the device may have a rectangular shape. The container may, in use, be placed (in a recess) along a short side or in a corner of said one of the halves.

The device may be provided with closing means for securing said two halves against each other during transport. The device may comprise any suitable closing means, such as a Velcro® tape, a zipper, a cord or cooperating magnets.

The device may be provided with carrying means, such as a handle and/or a shoulder strap.

The two halves may be hinged to each other.

The device may comprise a shell, such as a hard shell, comprising the two halves. Thus, when the devices is folded, the hard shell face outward, and so afford protection to the device during transport.

The container may be detachably arranged in the recess.

It will be understood that terms such as up, down, above, below, top, bottom etc. are relative terms only and descriptive of the orientation of the device in normal use.

Preferred and optional features of each of the aspects of the invention correspond to preferred and optional features of each other aspect of the invention.

### DESCRIPTION OF THE DRAWINGS

Non-limiting example embodiments of the invention will now be described with reference to the accompanying drawings, in which:

FIG. 1 shows an exploded, partial cross sectional view of a device in accordance with the invention.

FIG. 2 shows a close-up perspective view of a device in accordance with the invention.

FIG. 3 shows the device of FIGS. 1 and 2, in use.

FIG. 4 is an end view of the device in a folded position.

FIG. 5 is a plan view of a preferred embodiment of the device according to the invention in an unfolded position.

FIG. 6 is a cross-sectional view in the unfolded position.

Herein, like reference numbers in one figure refer to like reference numbers in another figure.

### DETAILED DESCRIPTION OF EXAMPLE EMBODIMENT

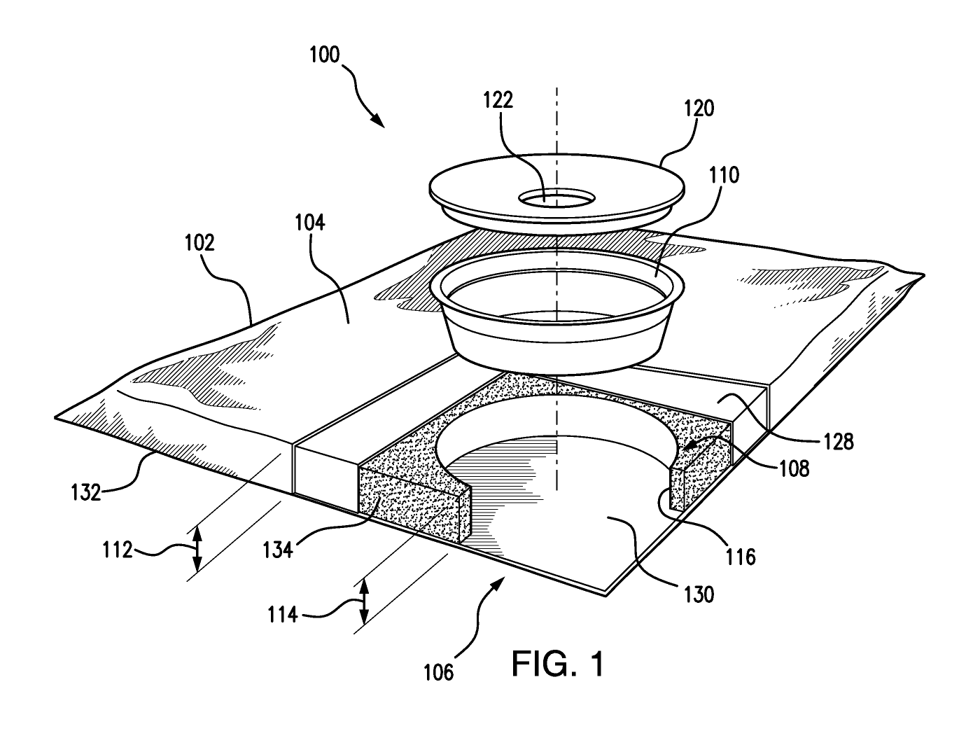

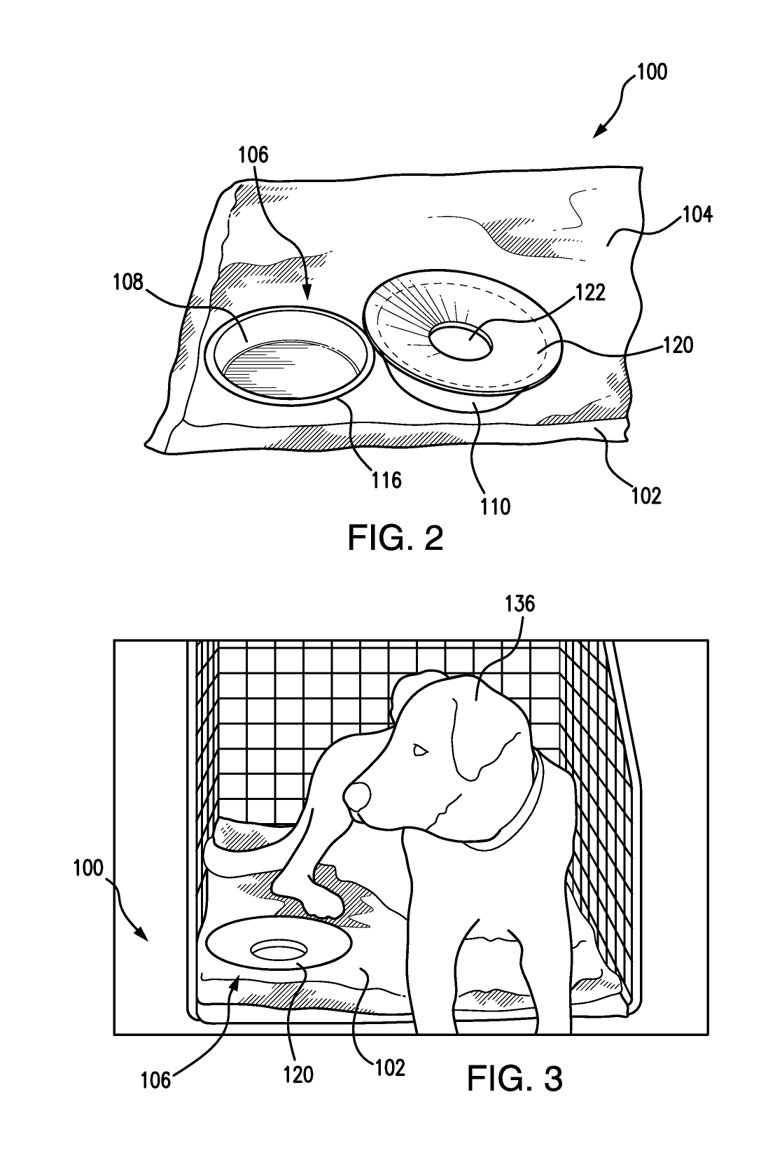

FIGS. 1 and 2 show a device 100 for pets (in the embodiment shown, in the form of a mat for a dog) comprising a base 102. The upper surface of the base provides a resting area 104 for a pet. In a corner of the resting area 104, there is a container-receiving area 106 in which there is a recess 108 (shown partially cut-away in FIG. 1).

The device 100 also comprises a container 110 (in the embodiment shown, a water bowl). The container 110 is sized so as to be removably received in the recess (as shown in FIG. 3).

The recess 108 is almost as deep as the thickness 112 of the base 102, but has a depth 114 slightly less than the thickness 112 of the base. The recess is lined with a hard plastics lining 116. The container 110 fits cooperatively in the lining 116. Thus, the container does not contact the surface upon which the device rests and its movement in relation to the base is limited by its engagement with the lining of the recess.

The container 110 is provided with a removable lid 120 having a central aperture 122. When installed in the container, the lid 120 is angled slightly towards the bottom 124 of the container. A pet is able to access the contents of the container through the aperture 122, whereas the downward-facing lid deflects any liquid impinging upon it and so functions as an anti-spill lip around the top of the container 110. The lid also presents a smooth transition from the upper resting area 104 of the base 102 (as shown in FIG. 3), which mitigates against the container being knocked or snagged by a pet in use, as might otherwise cause the container to be moved.

It will be appreciated that this need not present a significant problem for some animals, or in some applications (for example a heavy bowl, or a bowl which is fixed, e.g. integral to or latched into the recess). Accordingly, in some embodiments (not shown) the container is only partly recessed and extends partly above the resting area 104.

The base 102 is constructed from a flexible, resilient plastics material 128, (in the embodiment shown, the material being expanded polystyrene). This is lightweight, but flexible enough to permit the base to be folded or rolled, for storage. In addition, the material 128 of the base is resilient and so tends towards the flattened configuration shown in the figure, unless otherwise retained.

The base 102 is also provided with a flexible PVC-coating 130 (although other coatings may be employed, such as leather, polyurethane etc). The coating 130 is both washable and wipeable, as well as being water-impermeable. The coating is sealed (by ultrasonic welding or any other suitable method) around the periphery 132 of the base 102.

Optionally, the coating 130 may also be sealed around the recess 108, for example by gluing the lining 116 to the coating. In alternative embodiments (not shown) the coating may extend into the recess, so as to provide the recess with a lining.

The container-receiving area 106 is reinforced. As can be seen in the cut-away view of FIG. 1, the container-receiving area 106 is formed from a harder plastics material 134 (such as a higher density polystyrene material). This reinforcing material 134 is advantageously less compressible than the material 124 from which the major part of the body 102 is formed. The lining 116 may additionally (or alternatively) provide reinforcement to the container-receiving area 106.

Accordingly, and as illustrated in FIG. 3, in use when a pet 136 is resting on the resting area 104, the base does not compress in the container-receiving area 106 sufficient to expose or release the container 110 from the recess 108. The reinforcement also assists in keeping the container level, reducing the risk of spillage.

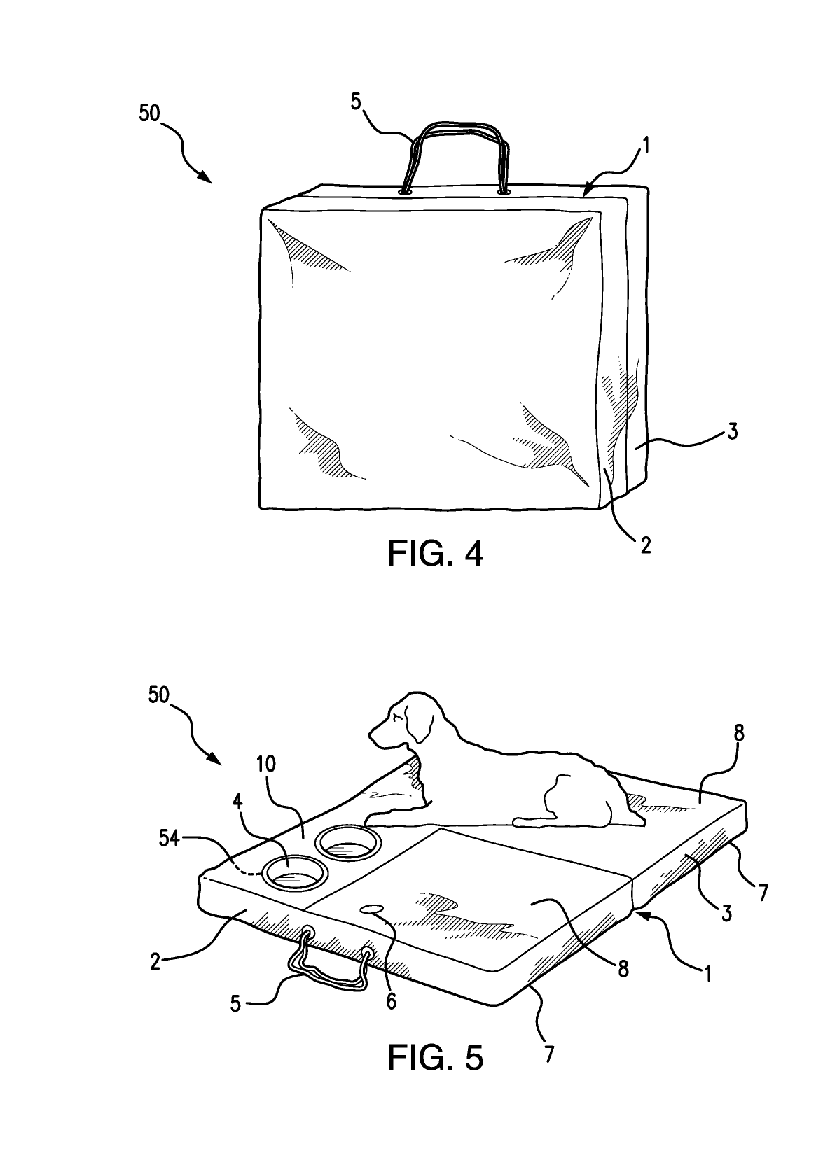

Another embodiment of the device 1 is shown in FIGS. 4-6.

As is evident from FIGS. 4-6 the device according to the invention is constituted by a device 50 for pets comprising a shell 1 having two halves hinged to each other and folding together, wherein one 2 of the halves comprises an area 10 for receiving a container 4, and wherein at least the other half 3 is designed as a sleeping area 8 for the pet, characterized in that said one 2 of the halves has a recess for fitting therein the container 4, and that said one 2 of the halves has a thickness corresponding at least to the height of the container, so that the container 4 is recessed into said one 2 of the halves and has a top edge substantially flush with a top surface of said one 2 of the halves when the device is in an unfolded position.

The halves of the device 50, together provide a base 52, having a resting area (sleeping area) 8, and the resting area comprising a container-receiving area 10 having a recess 54 (in the embodiment shown, two adjacent recesses) for fitting therein a container 4.

The device 50 has a sleeping area face 8 and laminated walls 7 on the opposite face.

In another embodiment, the sleeping area 8 of the device can have a cushion or a toy attached thereto (not shown/illustrated). Alternatively, the sleeping area can be covered with a warm blanket to enhance the pet's sense of well-being.

FIG. 4 shows the device 50 in a folded position ready for transport. In this position, the container 4 is filled with food or liquid according to owner's liking. Due to the fact that the container 4 is provided with a cover or a tearable foil, spilling or leakage of food/liquid onto the carpets of the vehicle is avoided.

The rectangular shape of device is suited for transport. The skilled person will appreciate that various modifications and changes can be made in the shape of the present device, such as e.g. a circular or square shape.

In the same way, the position of the container shown in FIG. 5 may include other positions. The position can be determined according to the size of the pet, and these embodiments are included in the invention.

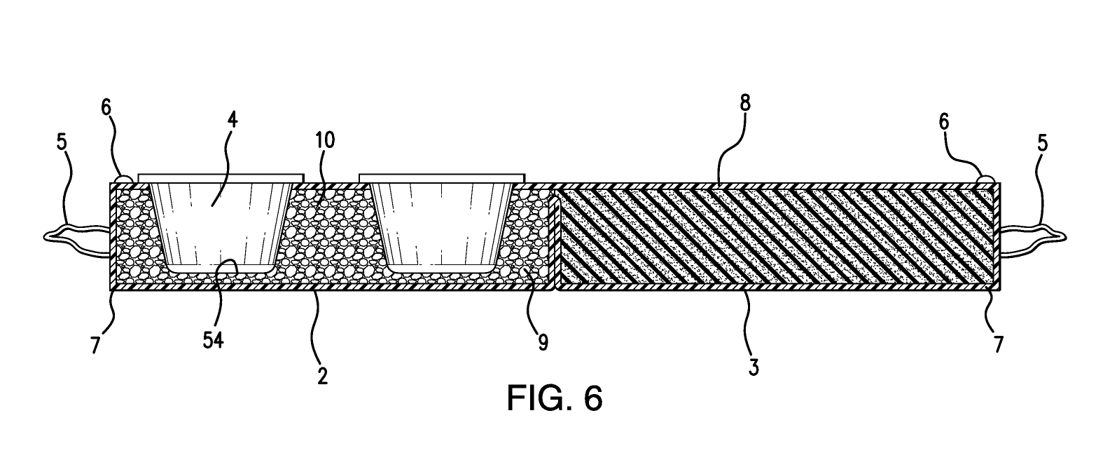

FIG. 6 also shows a closing means 6, located at the outer edges of the halves 2, 3, for convenient securing in the closed position. The device is provided with closing means 6 such as Velcro tapes, at least one zipper, a cord, cooperating magnets, or equivalent means. During transport the device is preferably also provided with carrying means 5, such as a handle and/or a shoulder strap, or the like.

The area 10 for receiving the container 4 has a core of such rigidity that the weight of the pet is unable to deform the core to such an extent that the container 4 is pulled loose from the recess 54. In this way, the risk that the pet, because of its weight, could compress said one 2 of the halves in the thickness direction so much that the container 4 comes loose, is reduced.

The core of the area 10 consists of hard cellular plastic, e.g. expanded polystyrene. Hard cellular plastic also has the advantage that its density is low, so that the device will be easier to carry along, especially when intended for a large pet.

In order to contribute to a comfortable sleeping area for the pet, said other half 3, (and optionally also the remainder of the half 2 of the device) suitably has/have a core of soft cellular plastic, e.g. foamed plastic, or foam rubber, so as to provide the pet with a soft sleeping area 8.

When in a folded position, the device is suitable for transport and can be subjected to heavy loads such as, for example, other suitcases or the like, which objects could deform the soft cellular plastic. For this reason, laminated walls 7, which protect the cellular plastic and retain the shape of the device, can be placed on the outside of the device.

To allow the device to be resistant to wear and other harsh conditions, said two halves 2, 3 preferably have a surface of a water-impermeable and anti-slipping material 9, wherein it is convenient that, when the device is the unfolded position, said other half 3 has an top surface of a material comfortable to lie on attached to the water-impermeable and anti-slipping material 9. Thereby, there is no risk that the cellular plastic absorbs water, nor that the pet slips on the device.

The container 4 suitably consists of a material chosen from metal, plastic or paper. Metal and plastic are durable, but need washing now and then, whereas disposable packages of paper material may be preferable on some occasions.

To retain food or liquid in the container 4 during transport, it is suitable that the container 4 comprises a cover or a tearable foil, or similar closure means.

Preferably, the two halves 2, 3 have a rectangular shape, and the container 4 is placed along a short side or in a corner of said one 2 of the halves. The rectangular shape makes it easy to dimension the device, without making it unwieldy, so that a large pet has enough sleeping space 8, and due to the fact that the container 4 is placed along a short side or in a corner, it can be ensured by appropriately positioning the device relative to the surrounding area that the pet stands on the device and puts weight on it when it is eating or drinking.

The scope of this disclosure is to be broadly construed. It is intended that this disclosure disclose equivalents, means, systems and methods to achieve the devices, activities and mechanical actions disclosed herein. For each mechanical element, mechanism, method and/or process disclosed, it is intended that this disclosure also encompasses in its disclosure and teaches equivalents, means, systems and methods for practicing the many aspects, mechanisms and devices disclosed herein. Additionally, this disclosure regards a device for pets and its many aspects, features and elements. Such a device for pets can be dynamic in its use an operation, this disclosure is intended to encompass the equivalents, means, systems and methods of the use of the tool and its many aspects consistent with the description and spirit of the operations and functions disclosed herein. The claims of this application are likewise to be broadly construed.

The description of the inventions herein in their many embodiments is merely exemplary in nature and, thus, variations that do not depart from the gist of the invention are intended to be within the scope of the invention. Such variations are not to be regarded as a departure from the spirit and scope of the invention.

Although the invention has been described hereinabove with particular reference to a number of exemplifying embodiments of the invention, it should be emphasized that it is not limited in its scope by these examples. The skilled person will appreciate the fact that different modifications and changes can be made to the present invention without departing from the scope of the invention, as it is defined by the accompanying claims.

1. A device for pets, comprising;
a base, having a resting area, and the resting area comprising a container-receiving area having a recess for fitting therein a container; and
a removable container received in the recess.

2. A device according to claim 1, wherein the container is cooperatively received in the recess.

3. A device according to claim 1, wherein the container is fully recessed into the base.

4. A device according to claim 1, wherein an upper part of the container is flush or substantially flush with the level of the resting area.

5. A device according to claim 1, wherein the container is provided with a lid.

6. A device according to claim 5, wherein, when installed on the container, the lid is flush, or substantially flush with the level of the resting area.

7. A device according to claim 5, wherein the lid slopes towards the base of the container, from the periphery thereof and/or wherein the lid is provided with an aperture, such that the lid defines an anti-spill lip around the container.

8. A device according to claim 1, wherein the container comprises an anti-spill lip around an upper periphery thereof.

9. A device according to claim 1, wherein the base is flexible.

10. A device according to claim 1, wherein the base is foldable or rollable.

11. A device according to claim 10, wherein the base is resilient, so as to have a tendency to unfurl or unroll to a generally flat configuration.

12. A device according to claim 10, having a closure, to selectively retain the base in a folded or rolled configuration.

13. A device according to claim 1, wherein the base comprises a hinge, such as an active hinge.

14. A device according to claim 1, comprising a padded base, so as to provide a comfortable resting area for a pet.

15. A device according to claim 1, wherein the container-receiving area is reinforced.

16. A device according to claim 15, wherein the container-receiving area is reinforced around a part, or entirely around, the recess.

17. A device according to claim 16, wherein the container-receiving area is reinforced through a part or substantially the entire thickness of the base, so as to provide a firm platform or support to a container in the recess.

18. A device according to claim 1, wherein the recess and container have tapered walls.

19. A device according to claim 1, wherein the container-receiving area is positioned proximal to an edge or corner of the base.

20. A device according to claim 1, wherein the device, or a region thereof, is formed from, coated or covered with a washable or wipeable material such as a smooth plastics material.

21. A kit of parts for a device for pets, comprising a base, having:
a resting area, and the resting area comprising a container-receiving area having a recess for fitting therein a container; and
at least one container, sized to be removably received in the recess.

22. A kit according to claim 21, comprising comprise one or more lids, for covering a said container, or the recess.

23. A kit according to claim 21, comprising one or more pre-packaged containers.

24. A device for pets, comprising two halves folding together, wherein one of the halves comprises a container receiving area for receiving a container, and wherein at least the other half is designed as a sleeping area for the pet, characterized in that said container receiving area in one of the halves has a recess for fitting therein the container, and that said one of the halves, at least in the container receiving area, has a thickness corresponding at least to the height of the container, so that the container is recessed into said one of the halves and has a top edge substantially flush with a top surface of said container receiving area in one of the halves when the device is in an unfolded position.
